(19) United States
(12) Patent Application Publication
(10) Pub. No.: US 2019/0190662 A1
(43) Pub. Date: Jun. 20, 2019

(54) METHOD AND APPARATUS FOR IMPROVING DOWNLINK BROADCAST FOR V2V COMMUNICATION IN WIRELESS COMMUNICATION SYSTEM

(71) Applicant: LG ELECTRONICS INC., Seoul (KR)

(72) Inventors: Youngdae LEE, Seoul (KR); Jian XU, Seoul (KR); Hanbyul SEO, Seoul (KR); Laeyoung KIM, Seoul (KR); Jonghyun PARK, Seoul (KR)

(73) Assignee: LG ELECTRONICS INC., Seoul (KR)

(21) Appl. No.: 16/300,024

(22) PCT Filed: May 11, 2017
(86) PCT No.: PCT/KR2017/004848

§ 371 Date: Nov. 8, 2018

Related U.S. Application Data
(60) Provisional application No. 62/334,473, filed on May 11, 2016.

(51) Int. Cl. H04L 1/18; H04W 76/11; H04W 4/46; H04L 29/12; H04W 4/06; H04W 72/04

(52) U.S. Cl. CPC H04L 1/1819; H04L 1/188; H04W 76/11; H04W 72/0406; H04L 61/2069; H04W 4/06; H04W 4/46

(57) ABSTRACT

Uplink (UL) feedback-based hybrid automatic repeat request (HARQ) retransmission may be proposed as an example for improving downlink (DL) broadcast for vehicle-to-everything (V2X) communication, especially for V2V (vehicle-to-vehicle) communication. An eNodeB (eNB) receives, from a neighboring eNB, an HARQ feedback transmitted by a user equipment (UE), and determines whether an HARQ is to be re-transmitted on the basis of the received HARQ feedback.

### BACKGROUND OF THE INVENTION

### Field of the Invention

The present invention relates to wireless communication and, more particularly, to a method and apparatus for improving downlink (DL) broadcast for vehicle-to-vehicle (V2V) communication in a wireless communication system.

### Related Art

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

LTE-based vehicle-to-everything (V2X) is urgently desired from market requirement as widely deployed LTE-based network provides the opportunity for the vehicle industry to realize the concept of ‘connected cars’. The market for vehicle-to-vehicle (V2V) communication in particular is time sensitive because related activities such as research projects, field test, and regulatory work are already ongoing or expected to start in some countries or regions such as US, Europe, Japan, Korea, and China.

3GPP is actively conducting study and specification work on LTE-based V2X in order to respond to this situation. In LTE-based V2X, PCS-based V2V has been given highest priority. It is feasible to support V2V services based on LTE PC5 interface with necessary enhancements such as LTE sidelink resource allocation, physical layer structure, and synchronization. In the meantime, V2V operation scenarios based on not only LTE PCS interface but also LTE Uu interface or a combination of Uu and PC5 has been considered. The maximum efficiency of V2V services may be achieved by selecting/switching the operation scenario properly.

When V2V communication is performed based on the Uu interface of LTE, the V2V message is transmitted to a network node such as a V2X server through an uplink (UL). The V2V message transmitted to the network node shall be transmitted to a plurality of vehicle/pedestrian user equipments (UEs) through a downlink (DL). At this time, it is a natural flow to use a broadcast mechanism such as multimedia broadcast multicast services (MBMS). Therefore, various discussions are underway to use DL broadcast for efficient V2V communication.

### SUMMARY OF THE INVENTION

The present invention provides a method and apparatus for improving downlink (DL) broadcast for vehicle-to-vehicle (V2V) communication in a wireless communication system. The present invention provides a method and apparatus for determining hybrid automatic repeat request (HARQ) retransmission based on uplink (UL) feedback. The present invention provides a method and apparatus for receiving UL feedback transmitted by a user equipment (UE) from a neighbor eNodeB (eNB) and determining HARQ retransmission based on the UL feedback.

In an aspect, a method for performing a hybrid automatic repeat request (HARQ) retransmission by an eNodeB (eNB) in a wireless communication system is provided. The method includes receiving a HARQ feedback that a user equipment (UE) has transmitted from a neighbor eNB, and determining whether to perform the HARQ retransmission based on the HARQ feedback.

In another aspect, an eNodeB (eNB) in a wireless communication system is provided. The eNB includes a memory, a transceiver, and a processor, operably coupled to the memory and the transceiver, that controls the transceiver to receive a hybrid automatic repeat request (HARQ) feedback that a user equipment (UE) has transmitted from a neighbor eNB, and determines whether to perform a HARQ retransmission based on the HARQ feedback.

HARQ retransmission can be efficiently performed in V2V communication by determining HARQ retransmission based on UL feedback.

### BRIEF DESCRIPTION OF THE DRAWINGS

FIG. 1 shows LTE system architecture.

FIG. 2 shows a block diagram of a user plane protocol stack of an LTE system.

FIG. 3 shows a block diagram of a control plane protocol stack of an LTE system.

FIG. 4 shows MBMS definitions.

FIG. 5 shows an enhanced MBMS (E-MBMS) logical architecture.

FIG. 6 shows PDSCH broadcast from a plurality of TPs according to an embodiment of the present invention.

FIG. 7 shows a method of performing HARQ retransmission by an eNB according to an embodiment of the present invention.

FIG. 8 shows a method of performing HARQ retransmission by an eNB according to another embodiment of the present invention.

FIG. 9 shows a wireless communication system to implement an embodiment of the present invention.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink. LTE-advance (LTE-A) is an evolution of the 3GPP LTE.

For clarity, the following description will focus on the LTE-A. However, technical features of the present invention are not limited thereto.

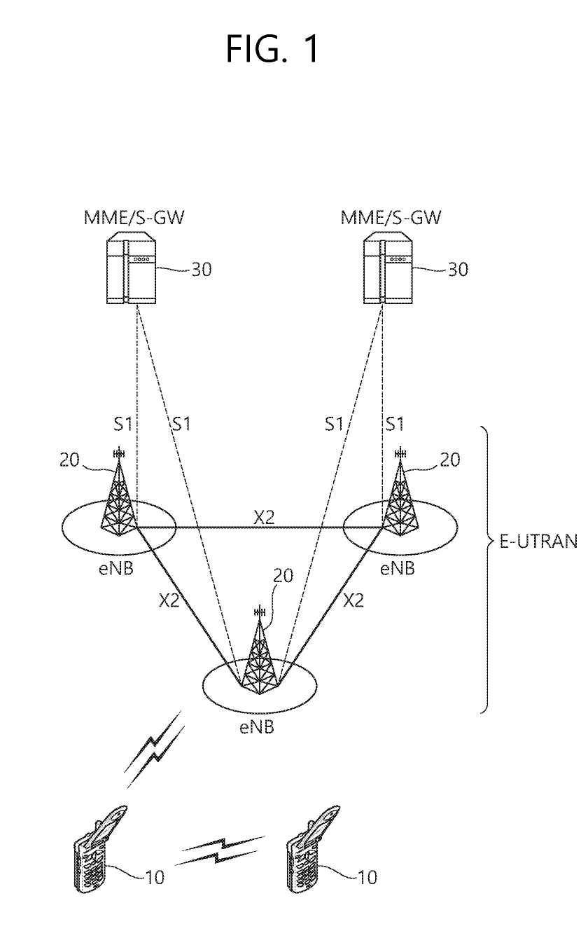

FIG. 1 shows LTE system architecture. Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), an access point, etc. One eNB 20 may be deployed per cell.

Hereinafter, a downlink (DL) denotes communication from the eNB 20 to the UE 10. An uplink (UL) denotes communication from the UE 10 to the eNB 20. A sidelink (SL) denotes communication between the UEs 10. In the DL, a transmitter may be a part of the eNB 20, and a receiver may be a part of the UE 10. In the UL, the transmitter may be a part of the UE 10, and the receiver may be a part of the eNB 20. In the SL, the transmitter and receiver may be a part of the UE 10.

The EPC includes a mobility management entity (MME) and a serving gateway (S-GW). The MME/S-GW 30 provides an end point of session and mobility management function for the UE 10. For convenience, MME/S-GW 30 will be referred to herein simply as a “gateway,” but it is understood that this entity includes both the MME and S-GW. A packet data network (PDN) gateway (P-GW) may be connected to an external network.

The MME provides various functions including non-access stratum (NAS) signaling to eNBs 20, NAS signaling security, access stratum (AS) security control, inter core network (CN) node signaling for mobility between 3GPP access networks, idle mode UE reachability (including control and execution of paging retransmission), tracking area list management (for UE in idle and active mode), packet data network (PDN) gateway (P-GW) and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on access point name aggregate maximum bit rate (APN-AMBR).

Interfaces for transmitting user traffic or control traffic may be used. The UE 10 is connected to the eNB 20 via a Uu interface. The UEs 10 are connected to each other via a PC5 interface. The eNBs 20 are connected to each other via an X2 interface. Neighboring eNBs may have a meshed network structure that has the X2 interface. The eNB 20 is connected to the gateway 30 via an S1 interface.

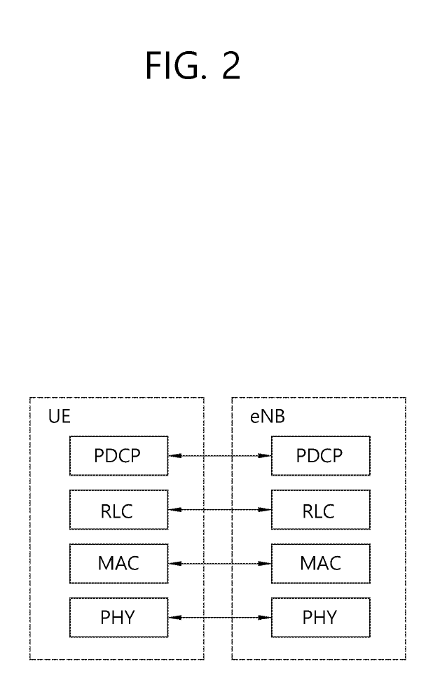

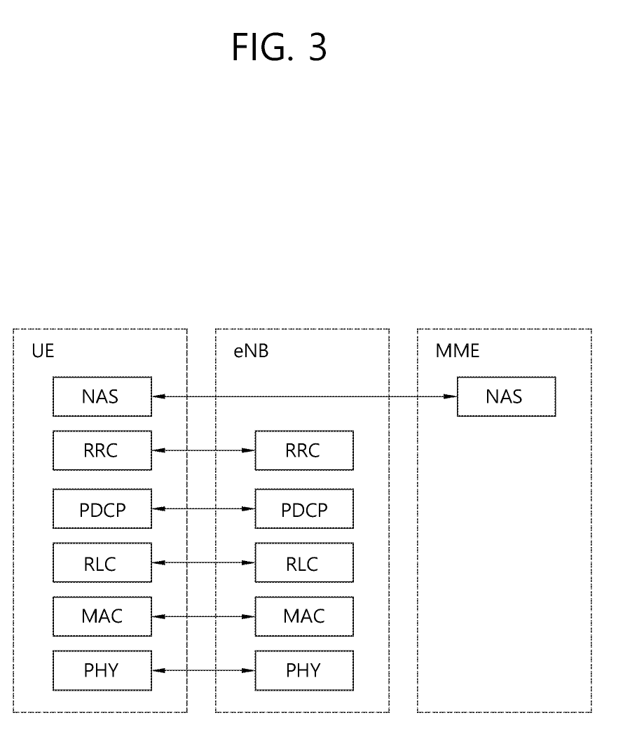

FIG. 2 shows a block diagram of a user plane protocol stack of an LTE system. FIG. 3 shows a block diagram of a control plane protocol stack of an LTE system. Layers of a radio interface protocol between the UE and the E-UTRAN may be classified into a first layer (L1), a second layer (L2), and a third layer (L3) based on the lower three layers of the open system interconnection (OSI) model that is well-known in the communication system.

A physical (PHY) layer belongs to the L1. The PHY layer provides a higher layer with an information transfer service through a physical channel The PHY layer is connected to a medium access control (MAC) layer, which is a higher layer of the PHY layer, through a transport channel. A physical channel is mapped to the transport channel. Data between the MAC layer and the PHY layer is transferred through the transport channel. Between different PHY layers, i.e., between a PHY layer of a transmission side and a PHY layer of a reception side, data is transferred via the physical channel.

A MAC layer, a radio link control (RLC) layer, and a packet data convergence protocol (PDCP) layer belong to the L2. The MAC layer provides services to the RLC layer, which is a higher layer of the MAC layer, via a logical channel. The MAC layer provides data transfer services on logical channels. The RLC layer supports the transmission of data with reliability. Meanwhile, a function of the RLC layer may be implemented with a functional block inside the MAC layer. In this case, the RLC layer may not exist. The PDCP layer provides a function of header compression function that reduces unnecessary control information such that data being transmitted by employing IP packets, such as IPv4 or Ipv6, can be efficiently transmitted over a radio interface that has a relatively small bandwidth.

A radio resource control (RRC) layer belongs to the L3. The RLC layer is located at the lowest portion of the L3, and is only defined in the control plane. The RRC layer controls logical channels, transport channels, and physical channels in relation to the configuration, reconfiguration, and release of radio bearers (RBs). The RB signifies a service provided the L2 for data transmission between the UE and E-UTRAN.

Referring to FIG. 2, the RLC and MAC layers (terminated in the eNB on the network side) may perform functions such as scheduling, automatic repeat request (ARQ), and hybrid ARQ (HARQ). The PDCP layer (terminated in the eNB on the network side) may perform the user plane functions such as header compression, integrity protection, and ciphering.

Referring to FIG. 3, the RLC and MAC layers (terminated in the eNB on the network side) may perform the same functions for the control plane. The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

A physical channel transfers signaling and data between PHY layer of the UE and eNB with a radio resource. A physical channel consists of a plurality of subframes in time domain and a plurality of subcarriers in frequency domain. One subframe, which is lms, consists of a plurality of symbols in the time domain. Specific symbol(s) of the subframe, such as the first symbol of the subframe, may be used for a physical downlink control channel (PDCCH). The PDCCH carries dynamic allocated resources, such as a physical resource block (PRB) and modulation and coding scheme (MCS).

A DL transport channel includes a broadcast channel (BCH) used for transmitting system information, a paging channel (PCH) used for paging a UE, a downlink shared channel (DL-SCH) used for transmitting user traffic or control signals, a multicast channel (MCH) used for multicast or broadcast service transmission. The DL-SCH supports HARQ, dynamic link adaptation by varying the modulation, coding and transmit power, and both dynamic and semi-static resource allocation. The DL-SCH also may enable broadcast in the entire cell and the use of beamforming.

A UL transport channel includes a random access channel (RACH) normally used for initial access to a cell, and an uplink shared channel (UL-SCH) for transmitting user traffic or control signals. The UL-SCH supports HARQ and dynamic link adaptation by varying the transmit power and potentially modulation and coding. The UL-SCH also may enable the use of beamforming.

The logical channels are classified into control channels for transferring control plane information and traffic channels for transferring user plane information, according to a type of transmitted information. That is, a set of logical channel types is defined for different data transfer services offered by the MAC layer.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting multimedia broadcast multicast services (MBMS) control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both UL and DL. The MTCH is a point-to-multipoint downlink channel for transmitting traffic data from the network to the UE.

UL connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RRC state indicates whether an RRC layer of the UE is logically connected to an RRC layer of the E-UTRAN. The RRC state may be divided into two different states such as an RRC idle state (RRC_IDLE) and an RRC connected state (RRC_CONNECTED). In RRC_IDLE, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE, no RRC context is stored in the eNB.

In RRC_CONNECTED, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion. A paging message is transmitted over all cells belonging to the same tracking area. If the UE moves from one tracking area (TA) to another TA, the UE will send a tracking area update (TAU) message to the network to update its location.

MBMS is described. It may be referred to as Section 15 of 3GPP TS 36.300 V13.2.0 (2015-12).

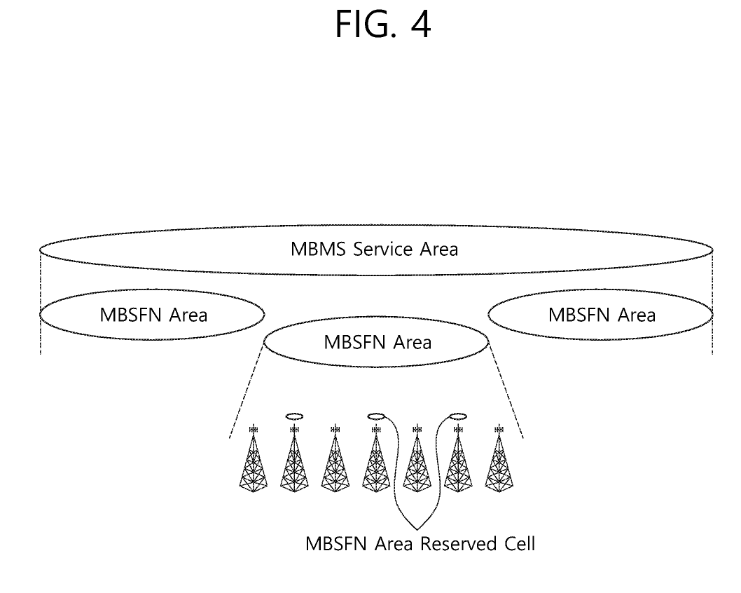

FIG. 4 shows MBMS definitions. For MBMS, the following definitions are introduced.
Multicast-broadcast single-frequency network (MBSFN) synchronization area: an area of the network where all eNBs can be synchronized and perform MBSFN transmissions. MBSFN synchronization areas are capable of supporting one or more MBSFN areas. On a given frequency layer, an eNB can only belong to one MBSFN synchronization area. MBSFN synchronization areas are independent from the definition of MBMS service areas.
MBSFN transmission or a transmission in MBSFN mode: a simulcast transmission technique realized by transmission of identical waveforms at the same time from multiple cells. An MBSFN transmission from multiple cells within the MBSFN area is seen as a single transmission by a UE.
MBSFN area: an MBSFN area consists of a group of cells within an MBSFN synchronization area of a network, which are coordinated to achieve an MBSFN transmission. Except for the MBSFN area reserved cells, all cells within an MBSFN area contribute to the MBSFN transmission and advertise its availability. The UE may only need to consider a subset of the MBSFN areas that are configured, i.e. when it knows which MBSFN area applies for the service(s) it is interested to receive.
MBSFN area reserved cell: A cell within a MBSFN area which does not contribute to the MBSFN transmission. The cell may be allowed to transmit for other services but at restricted power on the resource allocated for the MBSFN transmission.
Synchronization sequence: Each SYNC protocol data unit (PDU) contains a time stamp which indicates the start time of the synchronization sequence. For an MBMS service, each synchronization sequence has the same duration which is configured in the broadcast multicast service center (BM-SC) and the multi-cell/multicast coordination entity (MCE).
Synchronization period: The synchronization period provides the time reference for the indication of the start time of each synchronization sequence. The time stamp which is provided in each SYNC PDU is a relative value which refers to the start time of the synchronization period. The duration of the synchronization period is configurable.

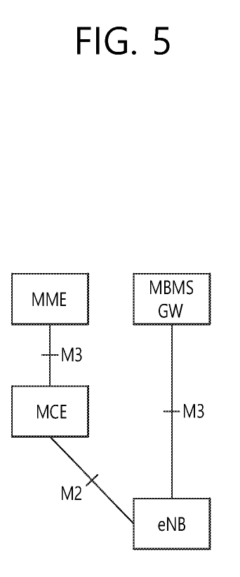

FIG. 5 shows an enhanced MBMS (E-MBMS) logical architecture. Referring to FIG. 5, the eNB is connected to the MCE via the M2 interface. The M2 interface is an E-UTRAN internal control plane interface. The MCE is connected to the MME via the M3 interface. The M3 interface is a control plane interface between the E-UTRAN and the EPC. The eNB is connected to the MBMS gateway (MBMS GW) via the M1 interface. The M1 interface is a user plane interface.

The MCE is a logical entity. The MCE may be part of another network element. Functions of the MCE are as follows.
The admission control and the allocation of the radio resources used by all eNBs in the MBSFN area for multi-cell MBMS transmissions using MBSFN operation: The MCE decides not to establish the radio bearer(s) of the new MBMS service(s) if the radio resources are not sufficient for the corresponding MBMS service(s) or may pre-empt radio resources from other radio bearer(s) of ongoing MBMS service(s) according to ARP. Besides allocation of the time/frequency radio resources this also includes deciding the further details of the radio configuration e.g. the modulation and coding scheme.
Deciding on whether to use single-cell point-to-multipoint (SC-PTM) or MBSFN.
Counting and acquisition of counting results for MBMS service(s).
Resumption of MBMS session(s) within MBSFN area(s) based on, e.g. the ARP and/or the counting results for the corresponding MBMS service(s).
Suspension of MBMS session(s) within MBSFN area(s) based e.g. the ARP and/or on the counting results for the corresponding MBMS service(s).

The MCE is involved in MBMS session control signaling. The MCE does not perform UE-MCE signaling. An eNB is served by a single MCE.

The MBMS GW is a logical entity. The MBMS GW may be part of another network element. The MBMS GW is present between the BM-SC and eNBs, principal functions is the sending/broadcasting of MBMS packets to each eNB transmitting the service. The MBMS GW uses IP multicast as the means of forwarding MBMS user data to the eNB. The MBMS GW performs MBMS session control signaling (session start/update/stop) towards the E-UTRAN via MME.

Transmission of a MBMS in E-UTRAN uses either MBSFN transmission or SC-PTM transmission. The MCE makes the decision on whether to use SC-PTM or MBSFN for each MBMS session.

Single-cell transmission of MBMS (i.e. SC-PTM transmission) is characterized as follows.
MBMS is transmitted in the coverage of a single cell;
One single-cell MCCH (SC-MCCH) and one or more single-cell MTCH (SC-MTCH(s)) are mapped on DL-SCH;
Scheduling is done by the eNB;
SC-MCCH and SC-MTCH transmissions are each indicated by a logical channel specific radio network temporary identity (RNTI) on PDCCH (there is a one-to-one mapping between temporary mobile group identity (TMGI) and group RNTI (G-RNTI) used for the reception of the DL-SCH to which a SC-MTCH is mapped);
A single transmission is used for DL-SCH (i.e. neither blind HARQ repetitions nor RLC quick repeat) on which SC-MCCH or SC-MTCH is mapped.

Multi-cell transmission of MBMS (i.e. MBSFN transmission) is characterized as follows.
Synchronous transmission of MBMS within its MBSFN area;
Combining of MBMS transmission from multiple cells is supported;
Scheduling of each MCH is done by the MCE;
A single transmission is used for MCH (i.e. neither blind HARQ repetitions nor RLC quick repeat);
A single transport block (TB) is used per TTI for MCH transmission, that TB uses all the MBSFN resources in that subframe;
MTCH and MCCH can be multiplexed on the same MCH and are mapped on MCH for p-t-m transmission;
The MAC subheader indicates the LCID for MTCH and MCCH;
The MBSFN synchronization area, the MBSFN area, and the MBSFN cells are semi-statically configured e.g. by operation and maintenance (O&)M;
MBSFN areas are static, unless changed by O&M (i.e. no dynamic change of areas);

Multiple MBMS services can be mapped to the same MCH and one MCH contains data belonging to only one MBSFN area. An MBSFN area contains one or more MCHs. An MCH specific MCS is used for all subframes of the MCH that do not use the MCS indicated in BCCH. All MCHs have the same coverage area.

Vehicle-to-everything (V2X) communication is described. V2X communication contains the three different types, i.e. vehicle-to-vehicle (V2V) communications, vehicle-to-infrastructure (V2I) communications, and vehicle-to-pedestrian (V2P) communications. These three types of V2X can use “co-operative awareness” to provide more intelligent services for end-users. This means that transport entities, such as vehicles, road side unit (RSU), and pedestrians, can collect knowledge of their local environment (e.g. information received from other vehicles or sensor equipment in proximity) to process and share that knowledge in order to provide more intelligent services, such as cooperative collision warning or autonomous driving.

V2X service is a type of communication service that involves a transmitting or receiving UE using V2V application via 3GPP transport. Based on the other party involved in the communication, it can be further divided into V2V service, V2I service, V2P service, and vehicle-to-network (V2N) service. V2V service is a type of V2X service, where both parties of the communication are UEs using V2V application. V2I service is a type of V2X service, where one party is a UE and the other party is an RSU both using V2I application. The RSU is an entity supporting V2I service that can transmit to, and receive from a UE using V2I application. RSU is implemented in an eNB or a stationary UE. V2P service is a type of V2X service, where both parties of the communication are UEs using V2P application. V2N service is a type of V2X service, where one party is a UE and the other party is a serving entity, both using V2N applications and communicating with each other via LTE network entities.

In V2V, E-UTRAN allows such UEs that are in proximity of each other to exchange V2V-related information using E-UTRA(N) when permission, authorization and proximity criteria are fulfilled. The proximity criteria can be configured by the mobile network operator (MNO). However, UEs supporting V2V service can exchange such information when served by or not served by E-UTRAN which supports V2X service. The UE supporting V2V applications transmits application layer information (e.g. about its location, dynamics, and attributes as part of the V2V service). The V2V payload must be flexible in order to accommodate different information contents, and the information can be transmitted periodically according to a configuration provided by the MNO. V2V is predominantly broadcast-based. V2V includes the exchange of V2V-related application information between distinct UEs directly and/or, due to the limited direct communication range of V2V, the exchange of V2V-related application information between distinct UEs via infrastructure supporting V2X Service, e.g., RSU, application server, etc.

In V2I, the UE supporting V2I applications sends application layer information to RSU. RSU sends application layer information to a group of UEs or a UE supporting V2I applications.

In V2P, E-UTRAN allows such UEs that are in proximity of each other to exchange V2P-related information using E-UTRAN when permission, authorization and proximity criteria are fulfilled. The proximity criteria can be configured by the MNO. However, UEs supporting V2P service can exchange such information even when not served by E-UTRAN which supports V2X service. The UE supporting V2P applications transmits application layer information. Such information can be broadcast by a vehicle with UE supporting V2X Service (e.g. warning to pedestrian), and/or by a pedestrian with UE supporting V2X Service (e.g. warning to vehicle). V2P includes the exchange of V2P-related application information between distinct UEs (one for vehicle and the other for pedestrian) directly and/or, due to the limited direct communication range of V2P, the exchange of V2P-related application information between distinct UEs via infrastructure supporting V2X service, e.g., RSU, application server, etc.

In V2X communication, messages such as common awareness messages (CAM), decentralized environmental notification messages (DENM), or basic safety messages (BSM) may be transmitted. The CAM includes information on a vehicle's type, a location, speed, a direction, etc., and may be periodically broadcasted by any vehicle. The DENM includes information on a type of a particular event and an area where the particular event has occurred, and may be broadcasted by an RSU or a vehicle. The BSM is included in the U.S. J2735 basic safety message, and have similar characteristics to those of the CAM. Through the BSM, an emergency brake warning, a front collision warning, an intersection safety support, a blind spot and line departure warning, a overtake warning, an out-of-control warning service may be provided.

DL broadcast may be used for V2X communication, in particular, V2V communication. That is, DL broadcast may be used for a V2V message to be transmitted to a UE supporting V2V communication. Accordingly, for V2X communication, a method of enhancing the existing DL broadcast is being discussed. In RAN1 in which the physical layer is discussed, the enhancement of DL broadcast has been in progress in the following direction. That is, in the case of DL multicast/broadcast, performance gains have been monitored through the following enhancement.
Dynamic scheduling for multicast/broadcast transmission: That is, scheduling based on a PDCCH of a TB associated with a TMGI
Semi-static scheduling for multicast/broadcast transmission
Use of a transport method based on a demodulation reference signal (DM-RS) from a multi-transmission point (TP) including reception for an idle UE: This does not mean the introduction of a new transmission mode (TM).
Single cell multicast based on a DMRS
PDSCHs transmitted by a plurality of TPs
PDSCH/PDCCH based on a CRS transmitted from a TP different from a TP from which system information is transmitted
PDSCH/enhanced PDCCH (EPDCCH) based on DM-RS transmitted from different TPs
Use of a normal cyclic prefix (CP)
HARQ feedback
Channel state information (CSI) feedback
A UE identifies which broadcast transmission (e.g. TMGI) is related thereto depending on the location of the UE, for example.

Furthermore, in RAN2 in which a radio interface protocol is discussed, the enhancement of DL broadcast has been in progress in the following direction. The following technical region is identified as potential enhancement for the Uu transmission of V2V service.
Both an MBSFN and SC-PTM may be used.
MBSFN/SC-PTM service enhancement based on a UE geographical location: it is assumed that an application/higher layer can provide location information necessary for DL broadcast. An AS layer mechanism is not necessary in order to help an application server to determine a broadcast region.
The necessity and solution (if necessary) for reducing an MBSFN/SC-PTM standby time may be taken into consideration. Possible enhancement (may be used for a user plane) chiefly focused on a control plane is as follows. In the case of a MBSFN, the use of a shorter MCCH modification cycle, a repetition cycle and a shorter MCH scheduling cycle (e.g. 10 ms) and a preconfigured multicast radio bearer (MRB) may be taken into consideration. In the case of SC-PTM, a shorter SC-MCCH modification cycle and a shorter repetition cycle may be taken into consideration.

It is difficult to satisfy DL capacity requirements for V2V service. If multiple transmission UEs are present, unicast transmission cannot satisfy capacity requirements. In particular, capacity requirements cannot be satisfied in a city or highway based on a result of evaluation. Furthermore, in particular, when a UE enters a new cell or new MBSFN region or a relatively long scheduling cycle (e.g. 40 ms) is configured in DL, it is difficult to satisfy DL delay requirements for V2V service.

In order to overcome the above problem, in the capacity and latency aspects for the Uu transmission of V2V service, the enhancement of both MBSFN transmission and SC-PTM transmission has been agreed. Hereinafter, the enhancement of potential DL broadcast is described in detail. More specifically, as described above, the present invention proposes a detailed method of enhancing DL broadcast and/or additional enhancement of DL broadcast for V2X communication based on the enhancement of DL broadcast that is being discussed.

### 1. PDSCHs Transmitted from a Plurality of TPs

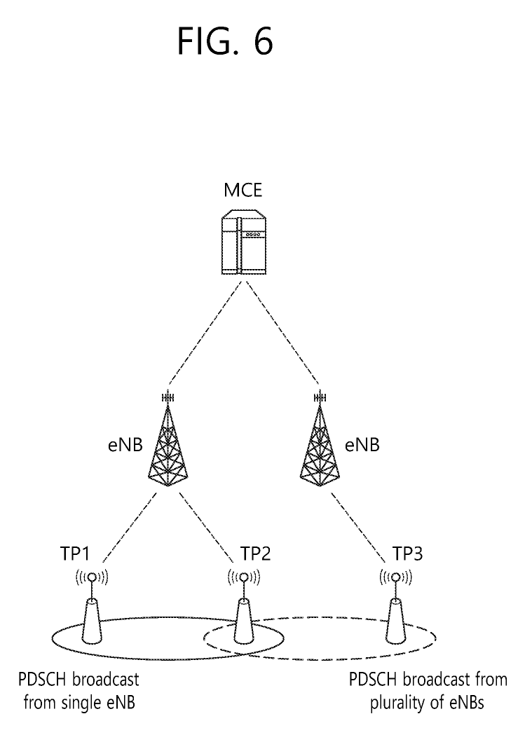

FIG. 6 shows PDSCH broadcast from a plurality of TPs according to an embodiment of the present invention. DL broadcast through PDSCHs from a plurality of TPs is advantageous for the support of V2V service. The plurality of TPs may belong to the same cell or different cells. When the plurality of TPs belongs to different cell, the plurality of TPs may belong to the same eNB or different eNBs.

When the plurality of TPs belongs to different eNBs, PDSCH broadcast may be scheduled by an MCE as in MBSFN transmission. That is, the MCE may periodically select a time/frequency resource and an MCS level for PDSCH broadcast with respect to a corresponding eNB. In contrast, when the plurality of TPs belongs to the same eNB, PDSCH broadcast may be scheduled by an eNB as in SC-PTM transmission. That is, if scheduling information, for example, is not provided by an MCE, the eNB may select a time/frequency resource and MCS level for PDSCH broadcast.

Regardless of whether the plurality of TPs belongs to the same eNB, in order to notify a UE of scheduled PDSCH broadcast, a PDCCH addressed by a G-RNTI may be used. In the UE viewpoint, PDSCH broadcast from a plurality of TPs may be scheduled like SC-PTM.

From a network viewpoint, an MBSFN region concept may be used when a PDSCH is broadcasted by a plurality of cells. An MCE may adjust a subframe that participates in multi-cell PDSCH broadcast using the existing M2 signaling. This is similar to the configuration of an MBSFN subframe. PDSCH broadcast from a plurality of TPs is not limited to an MBSFN subframe, but may be transmitted in a given subframe.

An MTCH or SC-MTCH may be mapped to a DL-SCH/PDSCH transmitted from a plurality of TPs/cells/eNBs. An MCCH or SC-MCCH may be mapped to a DL-SCH/PDSCH transmitted from a plurality of TPs/cells/eNBs. With respect to a specific TMGI, an MCE may determine a G-RNTI and DRX configuration for PDSCH broadcast in SC-PTM.

### 2. PDCCH-Based Dynamic Scheduling

Dynamic schedule of DL broadcast is advantageous for the support of V2V service. Single cell broadcast based on SC-PTM supports dynamic scheduling based on a PDCCH, whereas multi-cell broadcast based on an MBSFN may not support dynamic scheduling based on a PDCCH. Accordingly, MBSFN transmission needs to be scheduled based on dynamic scheduling based on a PDCCH. MBSFN broadcast dynamically scheduled by a PDCCH may use any one of a PDSCH and a PMCH.

### 3. HARQ Retransmission Based on UL Feedback

HARQ retransmission based on UL feedback is advantageous for the support of V2V service. In DL broadcast, a UE transmits HARQ feedback in UL. AN eNB performs HARQ retransmission when it receives the HARQ feedback. In this case, how UL feedback will be supported needs to be further discussed.

Initial transmission may be performed through a PDSCH or PMCH from a single cell or a plurality of cells. When initial transmission is performed from a single cell, corresponding retransmission is also performed from the corresponding single cell. Meanwhile, when initial transmission is performed from a plurality of cells of an MBSFN region or cluster, corresponding retransmission may be performed from a single cell or some or all of a plurality of cells of an MBSFN region or cluster that receives UL feedback. In this case, one of the following options may be taken into consideration.
Option 1: when an eNB receives HARQ feedback from a UE, it may determine whether to perform HARQ retransmission. When the eNB determines to perform HARQ retransmission, the eNB may perform HARQ retransmission from one or more cells including a cell that has received at least HARQ feedback.
Option 2: when a neighbor eNB delivers HARQ feedback, received from a UE, to an eNB, the eNB may determine whether to perform HARQ retransmission. When the eNB determines to perform HARQ retransmission, the eNB may perform HARQ retransmission in one or more cells.
Option 3: when an eNB delivers HARQ feedback, received from a UE, to an MCE, the MCE may determine whether to perform HARQ retransmission. When the MCE determines to perform HARQ retransmission, the MCE schedules HARQ retransmission in a scheduling cycle (e.g. MCH scheduling cycle) with respect to one or more cells through M2 signaling, and the eNB may perform HARQ retransmission in a corresponding cell.

Furthermore, when initial transmission is performed through a PDSCH/DL-SCH on which an MTCH or SC-MTCH is delivered, HARQ retransmission may be performed through a PDSCH/DL-SCH. Accordingly, the MTCH may be mapped to the DL-SCH/PDSCH for the HARQ retransmission.

When initial transmission is performed through a PMCH/MCH on which an MTCH is delivered, HARQ retransmission may be performed through a PDSCH or PMCH. Accordingly, the MTCH is mapped to the PMCH/MCH for HARQ initial transmission, but may be mapped to a DL-SCH/PDSCH for the HARQ retransmission. Although mapping between the MTCH and the PMCH/MCH is changed into mapping between the MTCH and the DL-SCH/PDSCH, a specific HARQ process may be maintained for both the HARQ initial transmission and the HARQ retransmission.

An MCCH and an SC-MCCH may also become the subject of HARQ retransmission. However, a UE may not transmit HARQ feedback through an MCCH and an SC-MCCH. The MCCH may be mapped to the MCH/PMCH for initial HARQ transmission, and may be mapped to a DL-SCH for HARQ retransmission.

When HARQ retransmission is scheduled, a PDCCH addressed by a G-RNTI or a new RNTI specified in retransmission may notify a UE of the scheduling of HARQ retransmission on an MCH/PMCH or a DL-SCH/PDSCH. Alternatively, a new MAC control element (CE) may notify a UE of the scheduling of HARQ retransmission on an MCH/PMCH or a DL-SCH/PDSCH. The transmission of a MAC CE may be indicated on a PDCCH addressed by a G-RNTI.

If a UE does not receive initial transmission or retransmission through an MCH/PMCH or a DL-SCH/PDSCH regardless of the transmission of NACK, the UE may monitor a PDCCH or MAC CE that schedules retransmission. Thereafter, the UE may receive retransmission through an MCH/PMCH or DL-SCH/PDSCH based on the PDCCH or MAC CE.

If a PDCCH is addressed by a G-RNTI, a PDCCH or MAC CE may indicate whether corresponding transmission is new transmission or retransmission. Furthermore, the PDCCH or MAC CE may selectively indicate a process ID. If corresponding transmission is retransmission, a UE may combine received data (i.e. from retransmission), with respect to the same process ID or the same G-RNTI, with data (i.e. initial transmission and/or previous retransmission) now present in a soft buffer with respect to a TB. Furthermore, the UE may attempt to decode the combined data within the soft buffer.

A maximum retransmission number or the last retransmission may be indicated in a PDCCH or MAC CE. If data has not been successfully decoded in a maximum retransmission number or the last retransmission, a UE may discard the data and empty a soft buffer.

If the data of new transmission or retransmission has not been successfully decoded, a UE may transmit NACK. However, if data has not been successfully decoded in a maximum retransmission number or the last retransmission, a UE may not transmit NACK.

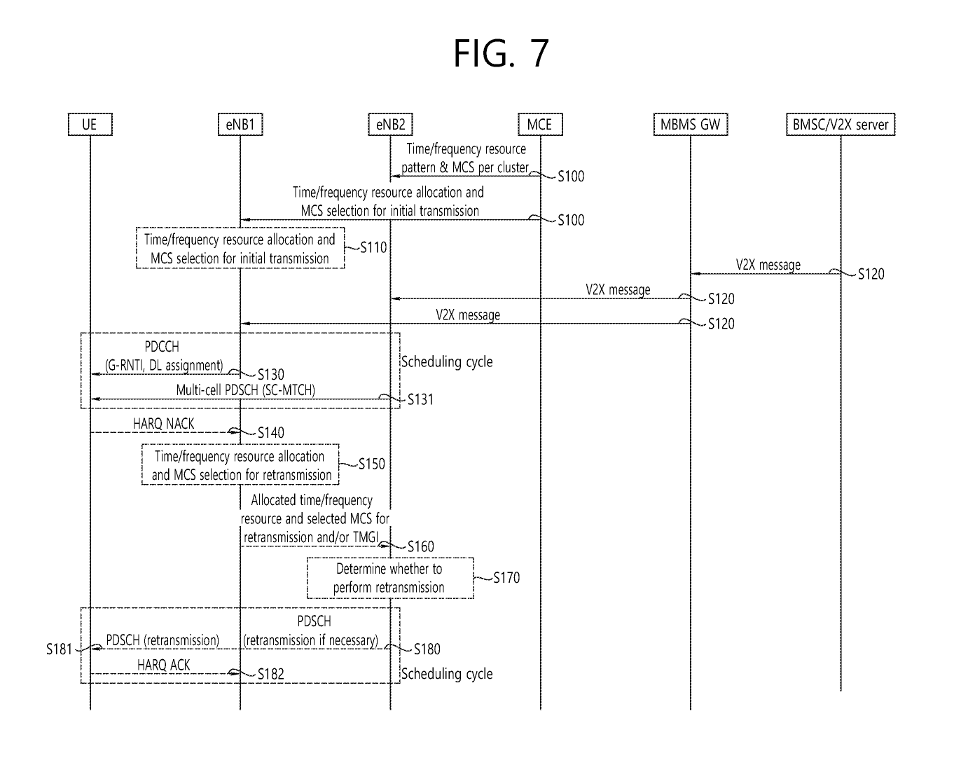

FIG. 7 shows a method of performing HARQ retransmission by an eNB according to an embodiment of the present invention. The contents of the present invention related to the aforementioned HARQ retransmission based on UL feedback may be applied to the present embodiment.

Referring to FIG. 7, at step S100, an MCE transmits a time/frequency resource pattern and MCS for each cluster to an eNB1 and an eNB2. The eNB1 and the eNB2 may perform MBSFN transmission or may perform SC-PTM transmission. The cluster may include a plurality of cells provided by a plurality of TPs. The plurality of TPs may belong to the same eNB or may belong to different eNBs. In the present embodiment, the plurality of TPs is assumed to belong to different eNBs (i.e. the eNB1 and the eNB2).

At step S110, the eNB1 and the eNB2 allocates time/frequency resources and selects an MCS for initial transmission in response to an instruction from the MCE.

At step S120, a V2X message is delivered from a V2X server to the eNB1 and the eNB2 via an MBMS GW.

At step S130, the eNB1 that now serves a UE transmits a PDCCH to the UE. The PDCCH may include a G-RNTI and DL assignment for PDSCH transmission. Thereafter, at step S131, the eNB1 and the eNB2 transmit a multi-cell PDSCH to the UE. The PDSCH may be mapped to an SC-MTCH.

If the UE does not successfully receive the multi-cell PDSCH, the UE transmits HARQ NACK to the eNB1 at step S140.

At step S150, the eNB1 allocates time/frequency resources for retransmission and selects an MCS.

At step S160, the eNB1 delivers the allocated time/frequency resources and the selected MCS for retransmission and/or TMGI to the eNB2.

At step S170, the eNB2 determines whether to perform retransmission based on information received from the eNB1.

When the eNB2 determines to perform retransmission, at step S180, the eNB 2retransmits a PDSCH to the UE. At step S181, the eNB1 that now serves the UE also retransmits a PDSCH to the UE. If the UE successfully receives the PDSCH, the UE transmits HARQ ACK to the eNB1 at step S182.

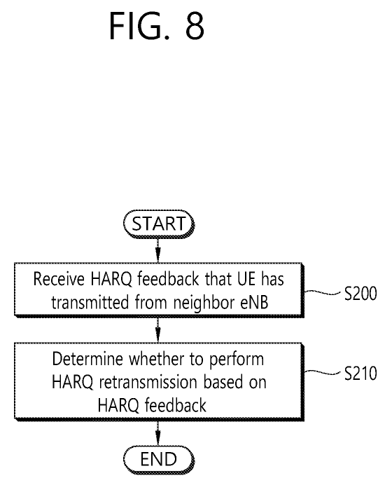

FIG. 8 shows a method of performing HARQ retransmission by an eNB according to another embodiment of the present invention. The contents of the present invention related to the aforementioned HARQ retransmission based on UL feedback may be applied to the present embodiment.

Referring to FIG. 8, at step S200, an eNB receives HARQ feedback, transmitted by a UE, from a neighbor eNB. At step S210, the eNB determines whether to perform HARQ retransmission based on the received HARQ feedback. If the eNB has determined to perform the HARQ retransmission, the eNB may perform the HARQ retransmission in one or more cells.

The HARQ feedback may be a response to initial transmission from one or more cells. The one or more cells may belong to an MBSFN region or cluster. The initial transmission may be performed through a PDSCH or PMCH. If the initial transmission is performed through the PDSCH, the HARQ retransmission may be performed through the PDSCH. If the initial transmission is performed through the PMCH, the HARQ retransmission may be performed through the PMCH or PDSCH.

The scheduling of the HARQ retransmission may be indicated by a PDCCH, addressed by a G-RNTI or an RNTI specific to the HARQ retransmission, or MAC CE. The transmission of the MAC CE may be indicated by a PDCCH addressed by the G-RNTI. The PDCCH or the MAC CE may indicate whether the transmission is initial transmission or retransmission. The PDCCH or the MAC CE may indicate a process ID. The PDCCH or the MAC CE may indicate a maximum retransmission number or the last retransmission

### 4. Reception of MBMS Service Based on Geographical Location of UE

With respect to V2V service, a TMGI may be assigned to address a specific geographical location (e.g. MBSFN region) mapped to a single cell or a plurality of cell sets in addition to a specific service. A network may assign a set of TMGIs to V2V service. Different TMGIs may be mapped to different geographical locations. A network may reuse a set of TMGIs in different geographical locations in order to cover the entire region provided by V2V service. A network may notify a UE of mapping between a TMGI and a specific geographical reference location.

If an MTCH/SC-MTCH on which a TMGI is delivered is broadcast from a cell and mapping between the TMGI and a geographical reference location is available, a UE may verify whether the location of the UE is close to the geographical reference location mapped to the TMGI. The UE may determine whether to receive an MTCH/SC-MTCH for V2V service based on the verification.

If mapping between a TMGI and a geographical reference location is not available or if a UE has not been notified of a TMGI mapped to V2V service, the UE may receive all MTCHs/SC-MTCHs on which a V2X message is delivered for the V2V service.

### 5. Shorter Scheduling Cycle for MBSFN

The shortest value of an MCH scheduling cycle in an MBSFN is now 40 ms. However, this value is not sufficient to support latency requirements for V2V service, that is, 100 ms if a message is delivered through a Uu interface. Accordingly, the introduction of a shorter MCH scheduling cycle may be proposed. The shortest value of the MCH scheduling cycle may be reduced to 10 ms.

### 6. Shorter MCCH/SC-MCCH Cycle for MBSFN and SC-PTM

When a UE enters a new MBSFN region or a new SC-PTM cell, the UE must read system information and an MCCH/SC-MCCH before it reads an MTCH/SC-MTCH on which a message is delivered for V2V service. Accordingly, a loss of continuous messages may occur due to a change in the MBSFN region or a change in the SC-PTM cell.

In order to reduce a loss of continuous messages attributable to a change in the MBSFN region and a change in the SC-PTM cell, to configure a modification cycle and repetition cycle for an MCCH and SC-MCCH to be shorter may be proposed. As a shorter value is introduced, the number of messages lost when they are received while a UE enters a new MBSFN region or a new SC-PTM cell can be reduced.

Meanwhile, latency necessary to read system information and an MCCH/SC-MCCH in a change in the MBSFN region and a change in the SC-PTM cell may cause a loss of continuous messages in DL. The reason for this is that several V2X messages generated from several vehicles are not lost until a UE reads system information and an MCCH/SC-MCCH because the UE cannot receive an MTCH/SC-MTCH.

### 7. Common Scheduling Information in SC-PTM Cell and MBSFN Region

As described above, in order to avoid a loss of continuous messages attributable to a change in the MBSFN region and a change in the SC-PTM cell, the introduction of common scheduling information common to a plurality of SC-PTM cells and/or a plurality of MBSFN regions may be proposed. Accordingly, when an MBSFN region or an SC-PTM cell is changed, a UE may receive an MTCH/SC-MTCH channel specific to V2V service before it reads an SIB13/SIB15/SIB20 and MCCH/SC-MCCH.

In the case of SC-PTM, the same G-RNTI specific to V2V service (or V2X service) may be used in a plurality of SC-PTM cells. Accordingly, when a UE enters a new SC-PTM cell, the UE may immediately monitor a PDCCH addressed by a G-RNTI in order to receive an SC-MTCH specific to V2V service.

In the case of an MBSFN, a G-RNTI may be used in a cell that supports one or more MBSFN regions specific to V2V service (or V2X service). Accordingly, when a UE enters a new MBSFN region, the UE [symbol] may receive an MAC CE, for example, MCH scheduling information about a specific MBSFN region, MCH scheduling information about a multi-MB SFN region or new scheduling information about V2X by immediately monitoring a PDCCH addressed by a G-RNTI. The MAC CE may be scheduled by the PDCCH and may be used to notify the UE of the scheduling of an MTCH specific to V2V service.

The G-RNTI specific to the V2V service may be broadcasted through system information. The system information may list a cell ID, an MBSFN region ID or a service region ID, and may indicate a G-RNTI specific to V2V service for listed cells, listed MBSFN regions or listed service regions. An MCE may assign a G-RNTI specific to V2V service to one or more eNBs.

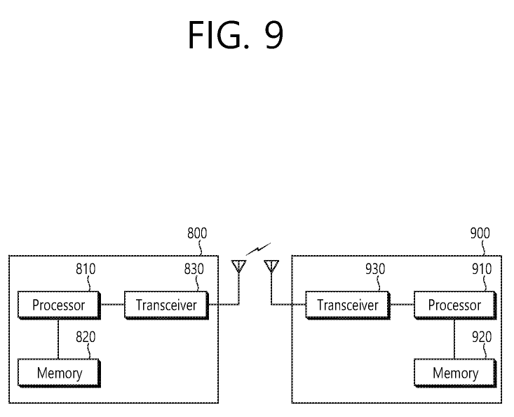

FIG. 9 shows a wireless communication system to implement an embodiment of the present invention.

An eNB 800 includes a processor 810, a memory 820 and a transceiver 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The transceiver 830 is operatively coupled with the processor 810, and transmits and/or receives a radio signal.

A UE 900 includes a processor 910, a memory 920 and a transceiver 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The transceiver 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The transceivers 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope of the present disclosure.

What is claimed is:

1. A method for performing a hybrid automatic repeat request (HARQ) retransmission by an eNodeB (eNB) in a wireless communication system, the method comprising:
receiving a HARQ feedback that a user equipment (UE) has transmitted from a neighbor eNB; and
determining whether to perform the HARQ retransmission based on the HARQ feedback.

2. The method of claim 1, further comprising performing the HARQ retransmission in at least one cell when it is determined to perform the HARQ retransmission.

3. The method of claim 1, wherein the HARQ feedback is a response to an initial transmission from at least one cell.

4. The method of claim 3, wherein the at least one cell belongs to a multicast-broadcast single-frequency network (MBSFN) area or a cluster.

5. The method of claim 3, wherein the initial transmission is performed via a physical downlink shared channel (PDSCH) or a physical multicast channel (PMCH).

6. The method of claim 5, wherein the HARQ retransmission is performed via the PDSCH when the initial transmission is performed via the PDSCH.

7. The method of claim 5, wherein the HARQ retransmission is performed via the PMCH or the PDSCH when the initial transmission is performed via the PMCH.

8. The method of claim 1, wherein scheduling of the HARQ retransmission is indicated by a physical downlink control channel (PDCCH), addressed by a group radio network temporary identifier (G-RNTI) or a RNTI specified to the HARQ retransmission, or a media access control (MAC) control element (CE).

9. The method of claim 8, wherein transmission of the MAC CE is indicated by the PDCCH addressed by the G-RNTI.

10. The method of claim 8, wherein the PDCCH or the MAC CE indicates whether a corresponding transmission is an initial transmission or a retransmission.

11. The method of claim 8, wherein the PDCCH or the MAC CE indicates a process identifier (ID).

12. The method of claim 8, wherein the PDCCH or the MAC CE indicates a maximum number of retransmissions or last retransmission.

13. An eNodeB (eNB) in a wireless communication system, the eNB comprising:
a memory;
a transceiver; and
a processor, operably coupled to the memory and the transceiver, that:
controls the transceiver to receive a hybrid automatic repeat request (HARQ) feedback that a user equipment (UE) has transmitted from a neighbor eNB, and
determines whether to perform a HARQ retransmission based on the HARQ feedback.
